(19) United States
(12) Patent Application Publication
(10) Pub. No.: US 2005/0188546 A1
(43) Pub. Date: Sep. 1, 2005

(54) Reciprocating electric shaver, inner cutter and inner cutter manufacturing method

(75) Inventors: Hiromi Uchiyama, Matsumoto (JP); Yukio Izumi, Matsumoto (JP)

Correspondence Address: KODA & ANDROLIA, 2029 CENTURY PARK EAST, SUITE 1140, LOS ANGELES, CA, 90067, US

(73) Assignee: IZUMI PRODUCTS COMPANY

(21) Appl. No.: 11/065,704

(22) Filed: Feb. 23, 2005

(30) Foreign Application Priority Data
Feb. 27, 2004 (JP) 2004-54027

(51) Int. Cl. B26B 19/02

(52) U.S. Cl. 30/346.51; 30/43.92

(57) ABSTRACT

A reciprocating electric shaver in which a plurality of elongated cutter blades (122) of an arch-form inner cutter (102) make a reciprocating motion while making sliding contact with an arch-form outer cutter (100) that has a hair introduction openings, so that hair introduced into the hair introduction openings is cut by the cutter blades (122), wherein the inner cutter (102) is formed by bending into an arch shape a thin plate in which a pair of side edge portions (120) that are parallel to the reciprocating direction of the inner cutter and a plurality of cutter blades (122) that are connected at both ends to the side edge portions (120) are integrally formed, and at least a part of each one of the cutter blades is bent with respect to the direction of length of the cutter blades.

### BACKGROUND OF THE INVENTION

1. Technical Field

The present invention relates to a reciprocating electric shaver in which the cutter blades of an inner cutter make a reciprocating motion while making sliding contact with the inside surface of a substantially arch-form outer cutter.

2. Description of the Related Art

Reciprocating electric shavers, in which an inner cutter makes a reciprocating motion while making sliding contact with the inside surface of an arch-form outer cutter, and hair that is introduced into openings (hair introduction openings) formed in this outer cutter is cut by the inner cutter, are well known as disclosed in, for instance, Japanese Patent Application Publication (Kokoku) No. S59-32151 and Japanese Patent Application Laid-Open (Kokai) Nos. S59-101182 and H10-323461. Electric shavers of this type use an assembled type inner cutter or an integral type inner cutter.

In an assembled type inner cutter, a plurality of cutter blades stamped into an arch shape are lined up at fixed intervals and held on a holding base as disclosed in the above-identified Japanese Patent Application Publication (Kokoku) No. S59-32151 and Japanese Patent Application Laid-Open (Kokai) No. S59-101182. In such an inner cutter, since a plurality of cutter blades must be formed and these cutter blades must be assembled on a cutter blade attachment member, the number of manufacturing steps is high, causing the problem of poor productivity.

On the other hand, in an integral type inner cutter, all of the cutter blades are integrated. For example, inner cutters of this type include inner cutters in which perpendicular slits are formed in a cylinder made of a metal, ceramic, etc., and the portions that remain between the slits are used as cutter blades. In another type of integral type inner cutter, a thin plate is bent into an arch shape, and cutter blades are made by forming perpendicular slits into this arch portion. There are also inner cutters in which a thin plate in which slits have been worked beforehand is bent into an arch shape as disclosed in Japanese Patent Application Laid-Open (Kokai) No. H10-323461.

An assembled type inner cutter in which the cutting edges of cutter blades are bent into substantially a wave shape is shown in Japanese Patent Application Publication (Kokoku) No. S59-32151; and FIGS. 8 and 9 show this inner cuter. FIG. 8 is a top view of the shape of the cutting edges 14 of the cutter blades 10 as seen from the blade surface side, while FIG. 9 shows a sectional view taken along the line IX-IX in FIG. 8. In this inner cutter, a so-called oblique cutting is made possible by setting the bending angle β of the cutting edges 14 in a specified angular range, thus alleviating the burden on the inner cutter and heightening the hair-cutting effect.

In FIG. 8, the reference number 16 indicates one of the hair introduction openings formed in the outer cutter. In FIG. 8, the hair introduction openings are in a circular shape. The reference number 18 indicates the hair. Here, the cutter blades 10 make a reciprocating motion in the x direction, which is a lateral or horizontal direction in FIG. 8. Furthermore, in FIG. 9, the rake angle α is formed in an acute angle. As seen from FIG. 9, the rake angle α is enclosed by blade surface 22, where the cutter blades 10 make sliding contact with the outer cutter, and the side surface 24, which is in continuous to the cutting edges 14 of the cutter blades 10. The sharpness can be improved by reducing this rake angle α.

In the assembled type inner cutter disclosed in the above-identified Japanese Patent Application Laid-Open (Kokai) No. S59-101182, as shown in FIG. 10, the cutter blades 20B located in the vicinity of both ends of the inner cutter 20 with respect to the reciprocating direction of the inner cutter 20 are bent into a wave shape. This wave shape is made in order to prevent the danger of damage to the blades by deformation, since the areas in the vicinity of both ends of the outer cutter tend to be deformed by external forces. In other words, as seen from FIG. 10, the cutter blades 20B are formed into a wave shape so that these cutter blades has an increased strength, thus preventing deformation of the outer cutter, while the cutter blades 20A located between these cutter blades 20B are in a linear shape.

In the assembled type inner cutter, since the respective cutter blades are separated, the bending working of the cutter blades is easy; however, as described above, the assembly of a plurality of cutter blades on a holding base is bothersome, and thus the productivity is poor. Furthermore, in the case of integral type inner cutters, the cutter blades are perpendicular to the reciprocating or lateral direction of the inner cutter, and such cutter blades are not bent. In other words, in the case of an inner cutter in which slits are formed in a cylinder or in an arch shaped thin plate, since a rotating cutter that make the slits makes a reciprocating motion perpendicular to the reciprocating or lateral direction x of the inner cutter, cutter blades which are bent with respect to the inner cutter's reciprocating or lateral direction cannot be formed.

Furthermore, in the inner cutter shown in the above-identified Japanese Patent Application Laid-Open (Kokai) No. H10-323461, parallel rectilinear grooves are formed in a thin plate by a rotating cutter that rotates to form a rake angle α in the cutter blades, the rectilinear cutter blades are separated by subjecting the opposite surfaces of this thin plate to planar cutting, and this metal plate is then bent into an arch shape. Thus, since a rotating cutter is used, the cutter blades are formed only in a rectilinear shape, and cutter blades which are bent with respect to the inner cutter's reciprocating or lateral direction cannot be formed.

### SUMMARY OF THE INVENTION

The present invention was devised in light of the problems in the prior art shavers.

It is an object of the present invention to provide an electric shaver in which the inner cutter is an integral type inner cutter so that the productivity is improved and in which oblique cutting of the hair by the cutter blades of the inner cutter is made possible so that the inner cutter has an improved sharpness, and the driving load of the inner cutter is reduced. It is another object of the present invention to provide a novel and unique inner cutter adapted to be used in an electric shaver, and it is still another object of the present invention to provide a method for manufacturing novel and unique inner cutters.

The above object of the present invention is accomplished by a unique structure of the present invention for a reciprocating electric shaver in which a plurality of mutually separated cutter blades provided in an arch-form inner cutter make a reciprocating motion while making sliding contact with a substantially arch-form outer cutter that has a plurality of hair introduction openings, so that hair that is introduced into the hair introduction openings of the outer cutter is cut by the cutter blades; and in the present invention,
the inner cutter is formed by bending into an arch shape a thin plate (made of metal or ceramic) in which a pair of side edge portions that are parallel to the reciprocating direction of the inner cutter and a plurality of cutter blades connected at both ends to the side edge portions are integrally formed, and
at least a part of each one of the cutter blades is bent with respect to the direction of length of said cutter blades (or with respect to the direction perpendicular to the reciprocating direction of the inner cutter).

The above object of the present invention is further accomplished by a unique structure of the present invention for an inner cutter adapted to be used in a reciprocating electric shaver; and in the present invention,
the inner cutter is made of a thin plate (made of metal or ceramic) in which a pair of side edge portions, which are parallel to the reciprocating direction (or to the lateral direction) of the inner cutter, and a plurality of cutter blades, which are connected at their both ends to the side edge portions, are integrally formed, and the thin plate is formed into an arch shape; and further
at least a part of each one of the cutter blades is bent with respect to the direction of length of said cutter blades (or with respect to the direction perpendicular to the reciprocating direction of the inner cutter).

Furthermore, the above object is accomplished by unique steps of the present invention for a method of manufacturing an inner cutter that is adapted to be used in a reciprocating electric shaver; and in the present invention, the method includes the steps of:
(a) forming an inner cutter plate member out of a thin plate by press-working so that the inner cutter plate member has cutter blades formed with bent regions which are bent with respect to the direction of length of the cutter blades,
(b) bending the inner cutter plate member into substantially an arch shape, and
(c) grinding the outer circumferential surface of the inner cutter plate member that is in the arch shape.

In the present invention, since the inner cutter is an integral type inner cutter, the productivity is good. Furthermore, since the cutter blades have bent regions, the cutter blades have sufficiently enhanced oblique cutting effect with an improved sharpness.

In the bent cutter blades, it is possible to form the bent regions only in the vicinity of the center of each elongated cutter blades and the regions on both sides of the center are formed straight to be rectilinear regions. In this structure, the sharpness of the area in the vicinity of the center, which makes the greatest contribution to the cutting of hair, can be improved, while the strength (rigidity) of the cutter blades can be maintained by the rectilinear regions on both sides of the bent regions, so that the dropping of shaving debris is facilitated.

In the present invention, it is desirable that an acute rake angle be formed in at least the vicinity of valley portions of the bent regions of the bent cutter blades of the inner cutter. The reason for this is that the sharpness can be greatly improved by forming the rake angle α in an acute angle.

In this structure, the hair that contacts the peaks (apices) positioned in the direction of advance of the cutter blades (among the bending points of the cutter blades) is conducted toward the valley side by the cutting edges 14; accordingly, the frequency with which hair is cut by the areas in the vicinity of the peaks is reduced. Thus, the load that is applied to the areas in the vicinity of the peaks is reduced, and damage can be avoided. Meanwhile, the hair has an increased chance of being captured and cut by the bending points constituting valleys that open in the direction of advance of the cutter blades. Accordingly, the load that is applied to the cutting edges in the vicinity of the valley portions of the cutter blades increases. When the rake angle α is formed in an acute angle, the cutting edges are most easily chipped in the vicinity of these valley portions, and portions are most susceptible to damage.

In the present invention, however, the cutting edges on both sides of the bent regions that constitute the valleys or the cutting edges that protrude in the shape of eaves with an acute rake angle are formed to be continuous to the bent regions, so that the cutting edges on both sides of the valleys reinforce each other. Accordingly, chipping of the cutting edges can be prevented.

Furthermore, by forming the hair introduction openings in the outer cutter with a square shape (including shapes such as parallelograms, rectangles, diamonds, etc.), and by appropriately setting the clamping angle of the hair introduction openings with the bent regions of the cutter blades, the sharpness of the cutting edge of the inner cutter can be improved. It is desirable to set this angle at as large an angle as possible within a range that does not allow the escape (movement) of hair, and an angle of 5° to 25°, for instance, is desirable.

### BRIEF DESCRIPTION OF THE DRAWINGS

FIG. 1 is a schematic front view of the internal structure of the reciprocating electric shaver according to the present invention;

FIG. 2 is a schematic side view thereof;

FIG. 3 is an unfolded top view of the inner cutter according to one embodiment of the present invention;

FIG. 4 is an enlarged view of one of the cutter blades of the inner cutter of the present invention;

FIG. 5 is a sectional view taken along the line V-V in FIG. 4;

FIG. 6 shows the manufacturing step of the inner cutter of the present invention;

FIG. 7 is an explanatory diagram of a cutter blade according to another embodiment of the present invention;

FIG. 8 shows the cutting edge shape of a conventional cutter blade;

FIG. 9 shows a sectional view taken along the line IX-IX in FIG. 8; and

FIG. 10 is a diagram showing another conventional inner cutter.

### DETAILED DESCRIPTION OF THE INVENTION

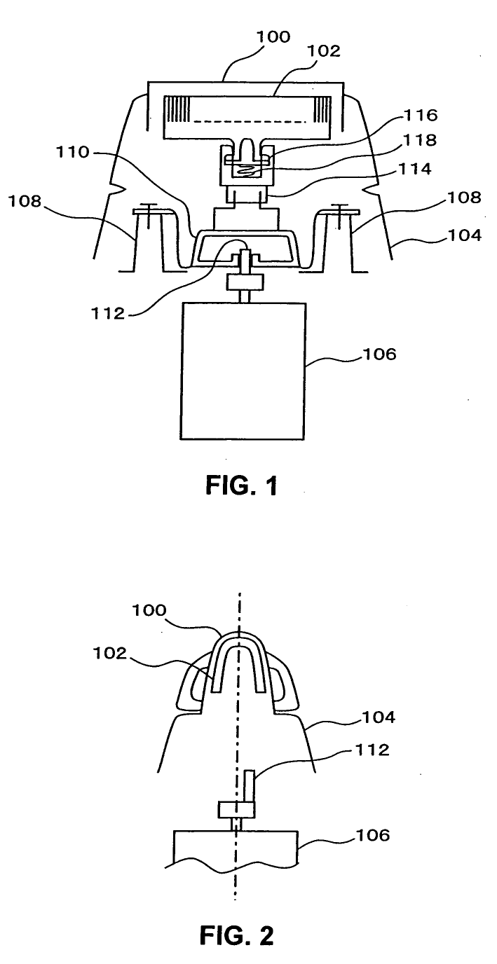

FIG. 1 shows schematically the internal structure of a reciprocating type electric shaver according to one embodiment of the present invention, the internal structure of the shaver being omitted; and FIG. 2 shows the shaver from the side.

In FIGS. 1 and 2, the reference number 100 is an arch-shaped outer cutter, and 102 is an arch-shaped inner cutter that makes a reciprocating motion within or under the outer cutter 100. The outer cutter 100 is fastened to a frame 104 of the shaver body (not shown). The outer cutter 100 is made of a thin plate of stainless steel, etc., and a plurality of openings (hair introduction openings) are formed in this thin metal plate by, for instance, press-stamping or etching. The outer cuter 100 can be made by electro-casting.

The inner cutter 102 is driven in a reciprocating motion by an electric motor 106. More specifically, a plane oscillator 110 made of a synthetic resin is suspended from the upper end surfaces of a pair of supporting columns 108 that extend in an upright attitude from the frame 104 of the shaver so that the oscillator 110 is free to oscillate laterally (or to the left and right), and a crank pin 112 that is fastened to the rotating shaft of the motor 106 is engaged with a long groove formed in the oscillator 110. As a result, when the rotating shaft of the motor 106 installed in the shaver body rotates, the oscillator 110 makes a lateral (or left and right) reciprocating motion.

A supporting column 114 is provided so as to protrude from this oscillator 110, and a holding portion 116 for the inner cutter 102 is held on the supporting column 114. The holding portion 116 is guided by the supporting column 114 so that the holding portion 116 is free to make an upward and downward motion; and a return inertia oriented in the upward direction toward the outer cutter 100 is applied to the holding portion 116 by a coil spring 118. As a result, the inner cutter 102 is driven in a reciprocating motion by the motor 106 while being held in elastic contact with the inside surface of the outer cutter 100 by the coil spring 118.

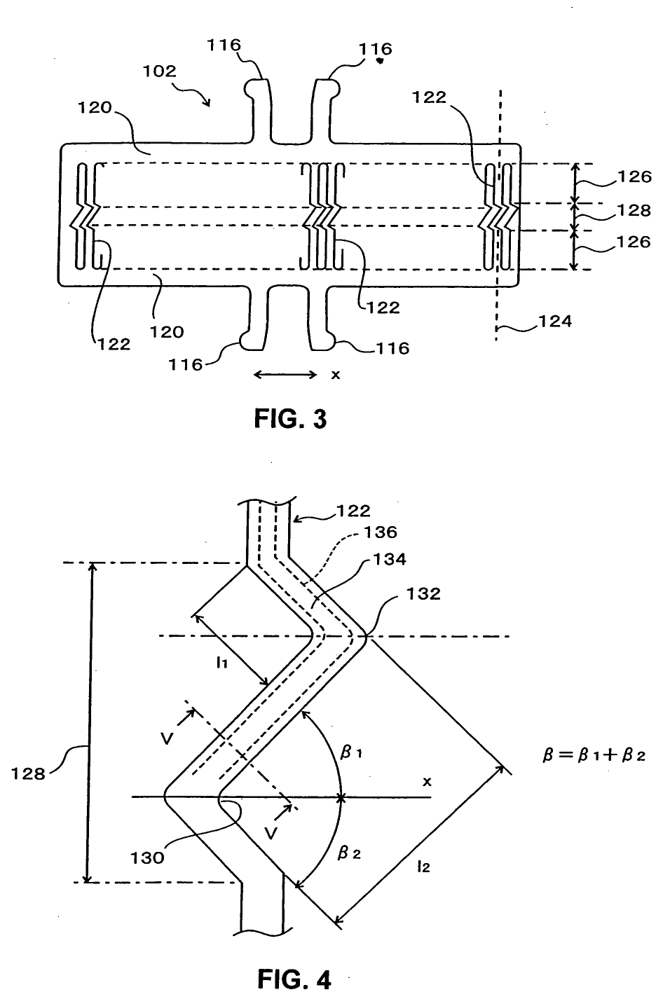

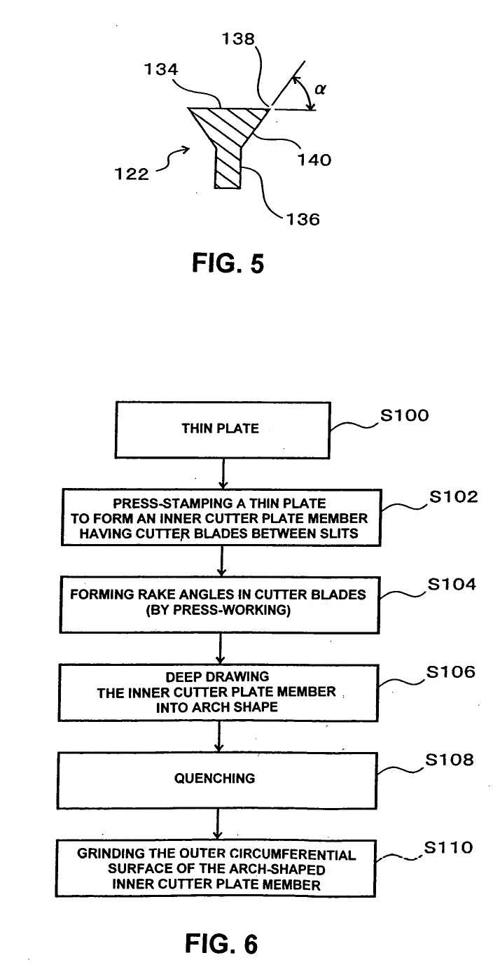

FIG. 3 shows the inner cutter 102 unfolded, FIG. 4 shows the bent regions of one of the cutter blades, FIG. 5 shows the bent region in cross section, and FIG. 6 shows the steps of the manufacturing process of the inner cutter.

The inner cutter 102 is comprised of side edge portions 120, which are parallel to the reciprocating direction x (or parallel to the lateral direction) of the inner cutter 102, and a plurality of cutter blades 122, which are formed in such a manner to connect the side edge portions 120. The inner cutter 102 is manufactured by performing press-working, grinding and the like to a thin plate which is made of stainless steel or a ceramic.

The cutter blades 122 includes rectilinear regions 126, which are parallel to an imaginary straight line 124 that is perpendicular to the reciprocating direction x (or to the lateral direction) of the inner cutter 102, and a bent region 128, which is positioned in the vicinity of the center (and between the rectilinear regions 126).

As seen from FIG. 4, the bent region 128 is bent substantially in the form of a crank, so that the bending angle β is approximately 90°; and though in the shown embodiment the angles β₁ and β₂ (β₁+β₂=β), which are formed with the direction of advance x by the two sides that enclose the valley portions 130 that open along the direction of advance x of the cutter blades 122, are not equal (β₁≠β₂), these angles can also be indeed equal (β₁=β₂). Furthermore, in the shown embodiment, the length 12 of the side between the valley portions 130 and adjacent peak part 132 is greater than the length I₁ of the side between the valley portion 130 or peak part 132 and the rectilinear regions 126.

As shown in FIG. 5, the cutting edges on both sides of each cutter blade 122 in the reciprocating direction x (or in the lateral direction) of the inner cutter are formed so as to have rake angles α (FIG. 5 shows only one, left-side, rake angle α). More specifically, each cutter blade 122 is comprised of a blade surface 134 that make sliding contact with the inside surface of the outer cutter 100 (see FIGS. 1 and 2), a rib 136 that is perpendicular to the blade surface, and two inclined side surfaces 140 that connect the cutting edges 138, which are at the side edges of the blade surface 134, and the rib 136; and the angle formed by the side surface 140 and the blade surface 134 make the rake angle α. The rake angle is in an acute angle and preferably 30° or less. Though the cutting edges of the cutter blades 122 have the acute rake angle for the entire length of the cutting edge in the above structure, the acute rake angle can be provided for only the cutting edges of at least the vicinity of the valley portions 130 of the bent regions of the cutter blade.

One example of the process of manufacturing the inner cutter 102 will be described with reference to FIG. 6.

First, a thin plate (made of metal or ceramic) is prepared (step S100), and an inner cutter plate member is obtained by press-stamping this thin plate so that the inner cutter plate member has an unfolded shape (external shape) of the inner cutter 102 and elongated gaps (slits) (step S102). The portions between the gaps (slits) make the elongated cutter blades 122.

Next, the rake angles α are formed by, for example, performing press-working on the inner cutter plate member (step S104). This press-working uses a mold, not shown, in which one of the molding elements (upper or lower) is made flat while the other molding element is formed with grooves therein, and the opening edges of these grooves are beveled in a triangullar cross-sectional shape. In the press-working process, rib portions that will constitute the cutter blades and are formed in step S102 are introduced into the grooves of the molding element, so that the rib portions are deformed so as to be widened by the joining faces of the upper and lower molding elements. The areas that are widened in the direction of width of the rib portions will be worked, by the circumferential grinding step (step S110) described below, so that they have the cutting edges with rake angles α.

After the areas that are widened have thus been formed in step S104 in the rib portions that will constitute the cutter blades, the inner cutter plate member is bent into an arch shape. This bending is performed so that the inner cutter plate member is, for example, presser-held between upper and lower molding elements and subjected to deep drawing (step S106).

Next, after performing quenching on this inner cutter plate member (step S108), grinding is performed to the outer circumferential surface (step S110) of the inner cutter plate member. As a result of this grinding, the top surfaces of the cutter blades that are widened are worked into flat to form the flat blade surfaces, and at the same time, the cutting edges having the rake angles α of an acute angle are formed. The inner cutter is thus completed. By setting the rake angle to be 30° or less, the cutter blades have a conspicuously improved sharpness. Though the above method forms the cutting edges of the cutter blades 122 so that the cutting edges have the acute rake angle for the entire length of the cutting edge, the acute rake angle can be formed for only the cutting edges of at least the vicinity of the valley portions 130 of the bent regions of the cutter blade.

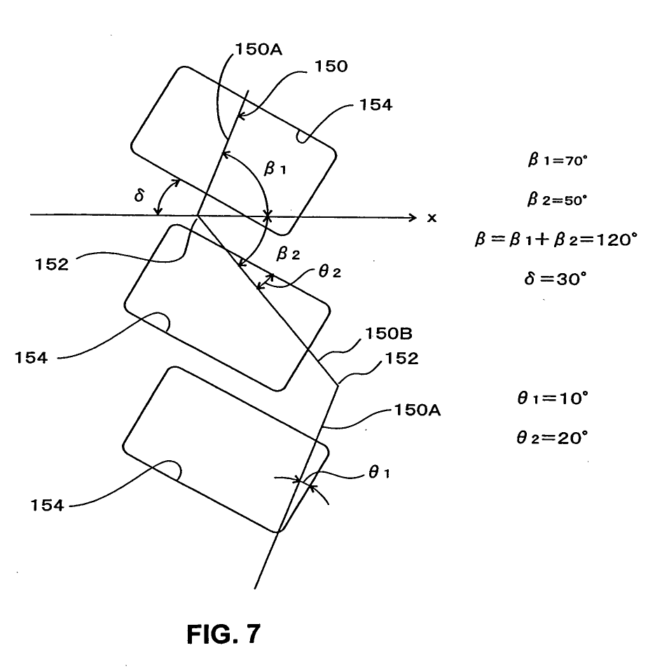

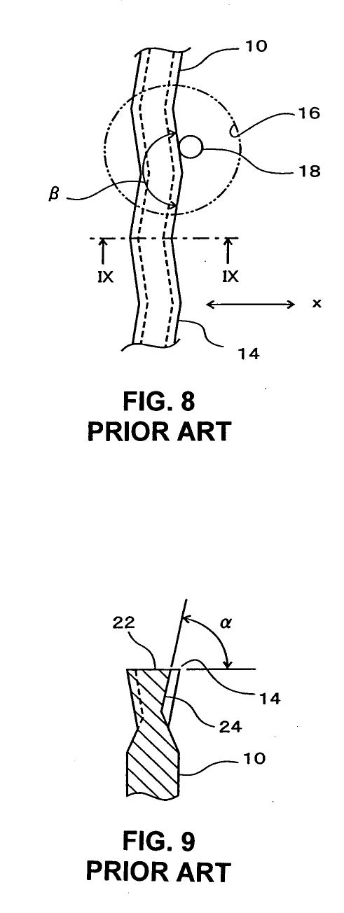

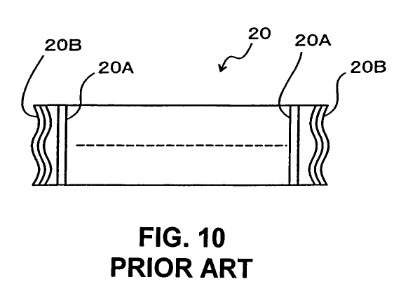

FIG. 7 shows one of the cutter blades of the inner cutter of another embodiment of the present invention.

In FIG. 7, the reference number 150 indicates the cutting edges in the bent regions of one of the cutter blades. The bending angle β (=β₁+β₂) of the bending point 152 is approximately 120°. Here, the angles β₁ and β₂ formed with the reciprocating direction x by the two sides 150A and 150B on either side of the bending point 152 are respectively 70° and 50°. The reference number 154 is one of the hair introduction openings of the outer cutter. These hair introduction openings 154 have a rectangular shape, and the long sides of this rectangular hair introduction opening are inclined by an angle of γ (γ=approximately 30°) with respect to the reciprocating direction x.

In this structure, the angle (clamping angle) θ₁ between one side 150Λ enclosing the bending point 152 of the cutter blade 150 and the shorter side of the hair introduction opening 154 is approximately 10°, and the angle (clamping angle) θ₂ between the other side 150B and the other longer side of the hair introduction opening 154 is approximately 20°. With this setting of the angles (clamping angles) θ₁ and θ₂ of the cutter blades 150 with the hair introduction openings 154 which is at smaller values (preferably 5 to 25°), the hair entering between the area of these angles θ₁ and θ₂ can be favorably cut without being allowed to move (i.e., without being allowed to escape).

In this embodiment, by setting the rake angles a of the cutter blades 150 at an acute angle as shown in FIG. 5, a much more favorable sharpness can be obtained. Furthermore, since the cutting edges of the two sides 150A and 150B enclosing the valleys at the bending points 152 constituting valleys that open in the direction of advance of the cutter blades 150 are connected to each other by the valleys and thus reinforced, deterioration of the sharpness of the cutting edges and chipping of the cutting edges can be prevented.

1. A reciprocating electric shaver in which a plurality of mutually separated cutter blades provided in an arch-form inner cutter are caused to make a reciprocating motion while being caused to make sliding contact with a substantially arch-form outer cutter that has a plurality of hair introduction openings, so that hair that is introduced into the hair introduction openings of the outer cutter is cut by said cutter blades, wherein
said inner cutter is formed by bending into an arch shape a thin plate in which a pair of side edge portions that are parallel to a reciprocating direction of the inner cutter and a plurality of cutter blades connected at both ends to said side edge portions are integrally formed, and
at least a part of each one of said cutter blades is bent with respect to a direction of length of said cutter blades.

2. The reciprocating electric shaver according to claim 1, wherein each of said cutter blades that are partly bent has a bent region in the vicinity of a center of said cutter blade and rectilinear regions at both ends of said cutter blade.

3. The reciprocating electric shaver according to claim 2, wherein a rake angle of cutting edges of at least a vicinity of valley portions of said bent regions of said cutter blades is formed in an acute angle.

4. The reciprocating electric shaver according to any one of claims 1 through 3, wherein
said hair introduction openings of said outer cutter have a square shape, and
a clamping angle between sides of said square shape hair introduction opening and said bent regions of said cutter blades is an acute angle in a range that allows no hair to escape.

5. An inner cutter adapted to be used in a reciprocating electric shaver, wherein
said inner cutter is made of a thin plate in which a pair of side edge portions that are parallel to a reciprocating direction of the inner cutter and a plurality of cutter blades connected at both ends to said side edge portions are integrally formed, said thin plate being in an arch shape, and
at least a part of each one of said cutter blades is bent with respect to a direction of length of said cutter blades.

6. A method for manufacturing an inner cutter adapted to be used in a reciprocating electric shaver, said method comprising the steps of:
(a) forming an inner cutter plate member out of a thin plate by pressing-work so that said inner cutter plate member has cutter blades formed with bent regions which are bent with respect to a direction of length of said cutter blades,
(b) bending said inner cutter plate member into substantially an arch shape, and
(c) grinding an outer circumferential surface of said inner cutter plate member that is in said substantially arch shape.

7. The method for manufacturing an inner cutter according to claim 6, wherein said step of forming said inner cutter plate member forms cutting edges that has a rake angle in an acute angle at least in the vicinity of valley portions of said bent regions of said cutter blades.
